(19) United States
(12) Patent Application Publication
(10) Pub. No.: US 2012/0124314 A1
(43) Pub. Date: May 17, 2012

(54) RECORDING MEDIUM

(75) Inventor: Takafumi ITO, Tokyo (JP)

(73) Assignee: Kabushiki Kaisha Toshiba, Tokyo (JP)

(21) Appl. No.: 13/050,450

(22) Filed: Mar. 17, 2011

(30) Foreign Application Priority Data
Nov. 16, 2010 (JP) 2010-256189

(51) Int. Cl. G06F 12/14; G06F 12/00

(52) U.S. Cl. 711/163; 711/200; 711/E12.103; 711/E12.001

(57) ABSTRACT

A recording medium according to an embodiment includes: a storing section including a first area in which a number-of-reproductions limited file is written and a second area in which at least one determination address in an address range of the first area, in which the number-of-reproductions limited file is written, and a number of readable times of the number-of-reproductions limited file are written; and a control section configured not to perform, after the number of readouts of reading out of data in the at least one determination address reaches the number of readable times, output of the number-of-reproductions limited file in response to a readout request for the number-of-reproductions limited file.

### CROSS-REFERENCE TO RELATED APPLICATION

This application is based upon and claims the benefit of priority from the prior Japanese Patent Application No. 2010-256189, filed in Japan on Nov. 16, 2010; the entire contents of which are incorporated herein by reference.

### FIELD

Embodiments described herein relate generally to a recording medium.

### BACKGROUND

In the past, flash memory cards such as an SD card have been spread. The flash memory cards are widely used as recording media because the flash memory cards have compact, user-friendly external shapes and sizes and because capacities thereof are increased.

Among such flash memory cards, there are flash memory cards having a function for protection of contents recorded therein. For example, a flash memory card having a media bind function is developed. The media bind function is a function of fixing contents in association with a medium using a medium ID and an encryption technique. Even if encrypted contents are copied to another medium, it is impossible to reproduce the contents from the other medium.

In some cases, audio video contents for promotion, for example, are stored in a flash memory card to be distributed. When a flash memory card is used as a promotion medium in this way, there is a request to limit to only a few times viewing and/or listening to such a promotion file.

However, a flash memory card has not been developed that permits reproduction of a predetermined file only a designated number of times and can disable reproduction exceeding the designated number of times with a card function alone without using a function of a host.

### BRIEF DESCRIPTION OF THE DRAWINGS

FIG. 1 is a block diagram showing a recording medium according to a first embodiment of the present invention;

FIG. 2 is an explanatory diagram showing a format of a memory section 21;

FIG. 3 is a flowchart for explaining the operation of the first embodiment;

FIG. 4 is an explanatory diagram for explaining a second embodiment of the present invention;

FIG. 5 is a flowchart for explaining the operation of the second embodiment;

FIG. 6 is an explanatory diagram for explaining a third embodiment of the present invention;

FIG. 7 is an explanatory diagram for explaining the operation of a CPRM circuit 14 in the third embodiment; and

FIG. 8 is a flowchart for explaining the operation of an MPU 13 in the third embodiment.

### DETAILED DESCRIPTION

Embodiments of the present invention are explained in detail below with reference to the accompanying drawings.

According to one embodiment, a recording medium includes: a storing section including a first area in which a number-of-reproductions limited file is written and a second area in which a determination address in an address range of the first area, in which the number-of-reproductions limited file is written, and a number of readable times of the number-of-reproductions limited file are written; and a control section configured to limit, after a number of readouts of reading out of data in the determination address reaches the number of readable times, an output of the number-of-reproductions limited file in response to a readout request for the number-of-reproductions limited file.

### First Embodiment

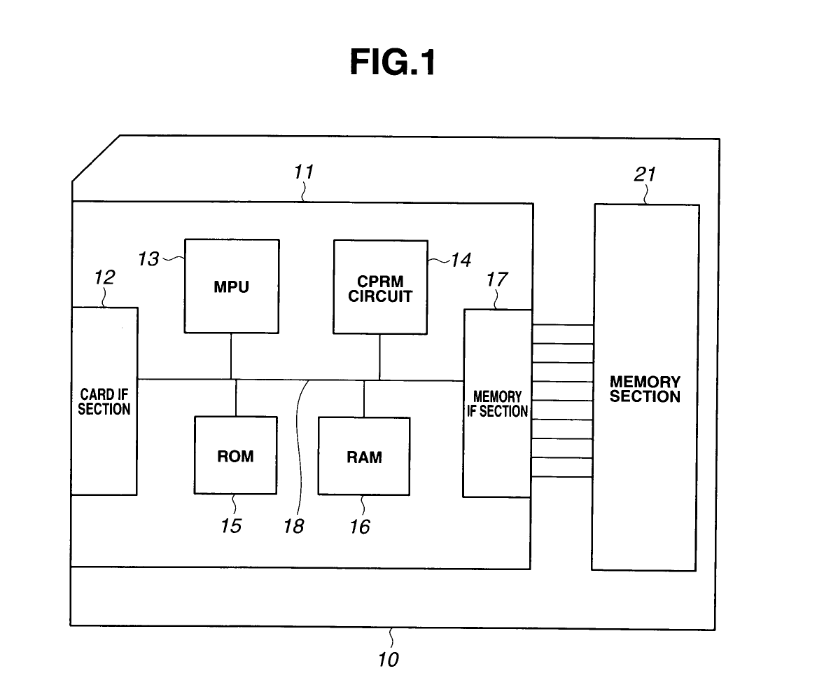

FIG. 1 is a block diagram showing a recording medium according to a first embodiment of the present invention.

In FIG. 1, a memory card 10 as a recording medium includes a memory section 21 and a control section 11 configured to control the memory section 21. As the memory section 21, for example, a multi-value NAND memory can be adopted.

The control section 11 includes a card interface (IF) section 12, a MPU 13, a CPRM circuit 14, a ROM 15, a RAM 16, and a memory interface (IF) section 17. The sections are connected by a bus 18.

The card IF section 12 is connected to a card IF section on a not-shown host side and configured to exchange data with the host. The ROM 15 stores therein software used in the MPU 13. The RAM 16 is a memory for work of the MPU 13. The CPRM circuit 14 is a circuit for realizing a protection function of a CPRM (Content Protection for Recordable Media) standard for content protection. The memory IF section 17 is connected to the memory section 21 and configured to exchange data with the memory section 21.

In this embodiment, in causing the memory section 21 to store contents as a file, the number of times of reproduction of which is desired to be limited, the MPU 13 sets a start logic address and an end logic address of the memory section 21, which the MPU 13 causes to store the file (hereinafter referred to as number-of-reproductions limited file), on the basis of an exclusive command from the host and sets first and second determination logic address serving as logic addresses between the start and end logic addresses. The MPU 13 causes the memory section 21 to store the first and second determination logic addresses in a system management area in the memory section 21.

The MPU 13 sets an area between the start logic address and the end logic address as read-only area. Consequently, thereafter, data writing in this logic address area causes an error.

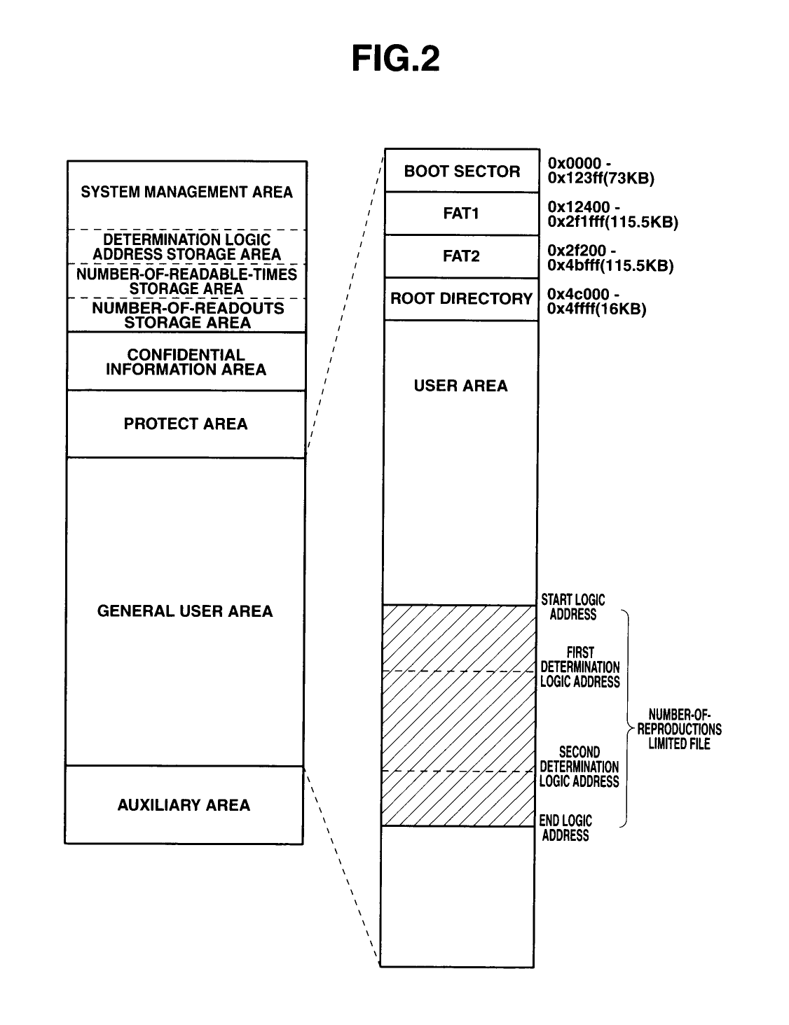

FIG. 2 is an explanatory diagram showing a format of the memory section 21.

As shown in FIG. 2, a system management area, a confidential information area, a protect area, a general user area, and an auxiliary area are provided in the memory section 21. The system management area is an area in which information internally used by the control section 11 is recorded. For example, firmware of the MPU 13, a logic address to physical address conversion table, parameters for the MPU 13, and a serial number are stored in the system management area.

Internal information for copy protection is stored in the confidential information area. The protect area is an area accessible when a user is authenticated. The general user area is an area accessible by a general user. The general user basically cannot access the other areas.

Further, in this embodiment, a determination logic address storage area, a number-of-readable-times storage area, and a number-of-readouts storage area are provided in the system management area.

In FIG. 2, an example in which FAT16 is adopted as a file system for the general user area is shown. A file system other than FAT16 may be adopted as the file system for the general user area.

The general user area includes, as shown in FIG. 2, a boot area (a boot sector), FAT areas (FAT1 and FAT2), a root directory area (a root directory), and a data area. For example, the boot area is an area of 73 KB from 0x0000 to 0x123ff. The FAT areas are an area of 115.5 KB from 0x12400 to 0x2f1ff and an area of 115.5 KB from 0x2f200 to 0x4bfff. The root directory area is an area of 16 KB from 0x4c000 to 0x4ffff.

Like the other files, the number-of-reproductions limited file is stored in a range of a predetermined logic address in the data area. In an example shown in FIG. 2, the number-of-reproductions limited file is stored between the start and end logic addresses (a hatched portion).

In this embodiment, in subjecting a file recorded in the memory section 21 to limitation of a number of reproduction times as the number-of-reproductions limited file, the MPU 13 causes, on the basis of an exclusive command from the host, the memory section 21 to store the first and second determination logic addresses between the start and end logic addresses in the determination logic address storage area in the system management area.

The MPU 13 receives an exclusive command from the host to cause the memory section 21 to store a number of readable times concerning the number-of-reproductions limited file in the number-of-readable-times storage area in the system management area. Further, the MPU 13 causes, every time data in the first and second determination logic addresses is read out, while counting up the number of readouts, the memory section 21 to store the number of readouts of the file in the number-of-readouts storage area in the system management area.

The MPU 13 reads out a file stored in the data area and outputs the file to the host according to a readout command from the host. In this case, in this embodiment, when the data in the first and second determination logic addresses stored in the system management area is read out, the MPU 13 counts up the number of readouts and determines whether or not the number of readouts has reached the number of readable times. If the number of readouts reaches the number of readable times, the MPU 13 outputs, in response to the next readout request, 0xFF to the host instead of the data of the number-of-reproductions limited file.

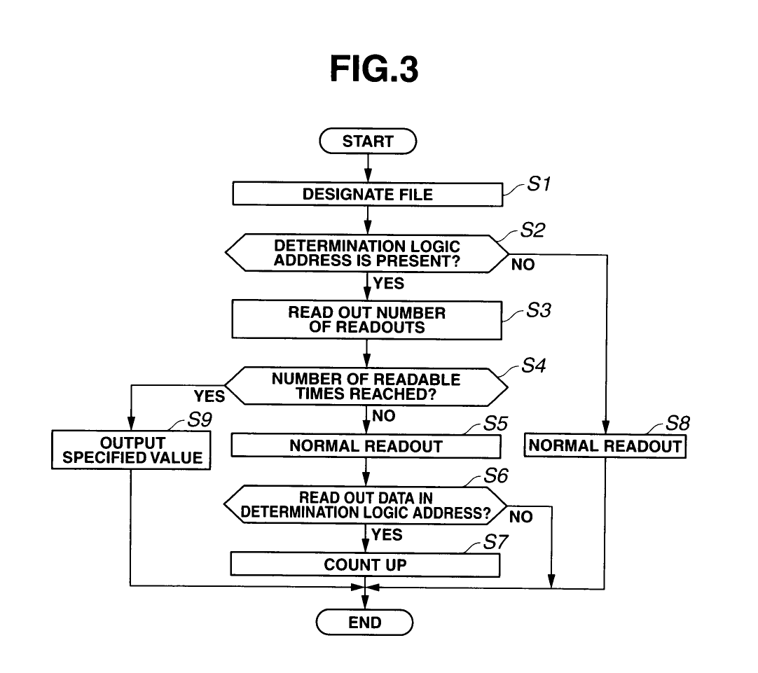

The operation of the embodiment configured as explained above is explained below with reference to FIG. 3. FIG. 3 is a flowchart for explaining the operation of the first embodiment.

Writing of a file in the memory section 21 is controlled by the not-shown host. The MPU 13 writes a file supplied from the host in a predetermined address range of the memory section 21 according to a command from the host.

When the file is the number-of-reproductions limited file, the MPU 13 writes, according to an exclusive command from the host, the first and second determination logic address set between the start and end logic address of the number-of-reproductions limited file in the determination logic address storage area in the system management area of the memory section 21. Further, the MPU 13 writes, according to an exclusive command from the host, information concerning the number of readable times, which specifies the number of times of reproduction of the number-of-reproductions limited file, in the number-of-readable-times storage area in the system management area. The MPU 13 initializes the information stored in the number-of-readable-times storage area in the system management area.

A user inserts the memory card 10 having the number-of-reproductions limited file stored therein into a predetermined host and performs reproduction of the number-of-reproductions limited file. When the memory card 10 is inserted into the card IF section of the not-shown host, the MPU 13 receives power supply from the host and starts operation.

When read out of the number-of-reproductions limited file is instructed from the host in step S1 in FIG. 3, in step S2, the MPU 13 determines whether or not a determination logic address concerning the file designated to be read out is stored in the determination logic address storage area. As for a file, the determination logic address of which is not stored, the MPU 13 shifts the processing to step S8 and performs normal readout.

When the file designated to be read out is the number-of-reproductions limited file, the determination logic address of which is stored, in step S3, the MPU 13 reads out information concerning the number of readouts from the number-of-readouts storage area in the system management area. Subsequently, in step S4, the MPU 13 reads out the number of readable times from the number-of-readable-times storage area in the system management area and determines whether or not the read-out number of readouts has reached the number of readable times.

If the number of readouts has not reached the number of readable times, in the next step S5, the MPU 13 performs normal readout. In the normal readout in step S5, stop and the like of the readout are also possible. The MPU 13 stops, halfway in the readout of the number-of-reproductions limited file, the readout when a command for stopping the readout is delivered from the host.

In the normal readout in step S5, the MPU 13 determines whether or not data in the determination logic address is read out (step S6). If both the data in the first and second determination logic addresses are read out in the normal readout in step S5, the MPU 13 shifts the processing to step S7, counts up the number of readouts, and updates the information in the number-of-readouts storage area. If the data in the first and second determination logic addresses are not read out in the normal readout in step S5, the MPU 13 ends the processing without counting up the number of readouts.

The MPU 13 repeats the flow shown in FIG. 3 every time a file stored in the memory section 21 is reproduced. If the number of readouts of the number-of-reproductions limited file stored in the memory section 21 reaches the number of readable times, the MPU 13 shifts the processing from step S4 to step S9. In step S9, the MPU 13 outputs a specified output, for example, 0xFF instead of the data of the number-of-reproductions limited file designated by the user to be read out.

In this way, in this embodiment, the determination logic address for determining readout of the number-of-reproductions limited file and the number of readable times are written in the system management area of the memory that the general user cannot directly access. When the number-of-reproductions limited file is read out, read out of data in the determination logic address is detected and the number of readouts is updated. If the number of readouts reaches the number of readable times, in the next readout, a specified value is output instead of the data of the number-of-reproductions limited file. Consequently, even when a general-purpose apparatus is used on the host side, it is possible to limit, in the memory card alone, the number of times of reproduction of the number-of-reproductions limited file to a desired number of times.

In the example explained in this embodiment, if the number of readouts reaches the number of readable times, the specified value is output in the next readout. However, any data may be output other than the data of the number-of-reproductions limited file. Further, the data output may be prohibited.

In this embodiment, readout of the number-of-reproductions limited file is detected according to readout of the data in the two first and second determination logic addresses. However, readout of the number-of-reproductions limited file may be determined according to readout of data in one or three or more determination logic addresses.

### Second Embodiment

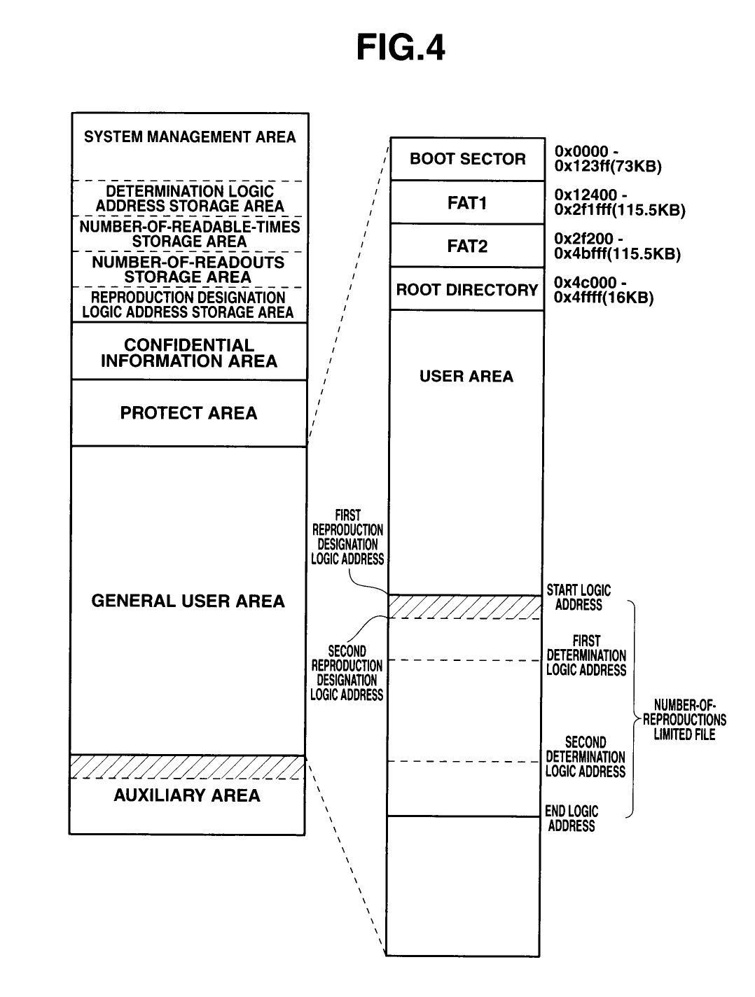

FIG. 4 is an explanatory diagram for explaining a second embodiment of the present invention. A hardware configuration of this embodiment is the same as that of the first embodiment. Only memory control by the MPU 13 is different from that of the first embodiment.

In this embodiment, as shown in FIG. 4, a related file (a hatched portion) related to the number-of-reproductions limited file can be recorded in the auxiliary area. The related file is written in the auxiliary area by the MPU 13 according to an exclusive command from the host. Further, the MPU 13 writes first and second reproduction designation logic addresses in a reproduction designation logic address storage area in the system management area according to an exclusive command from the host.

In this embodiment, if the number of readouts reaches the number of readable times, when reproduction of the number-of-reproductions limited file is instructed next, the MPU 13 reads out data of the related file stored in the auxiliary area from the first reproduction designation logic address corresponding to the start logic address of the number-of-reproductions limited file and outputs the data instead of data in the second reproduction designation logic address in a predetermined address range.

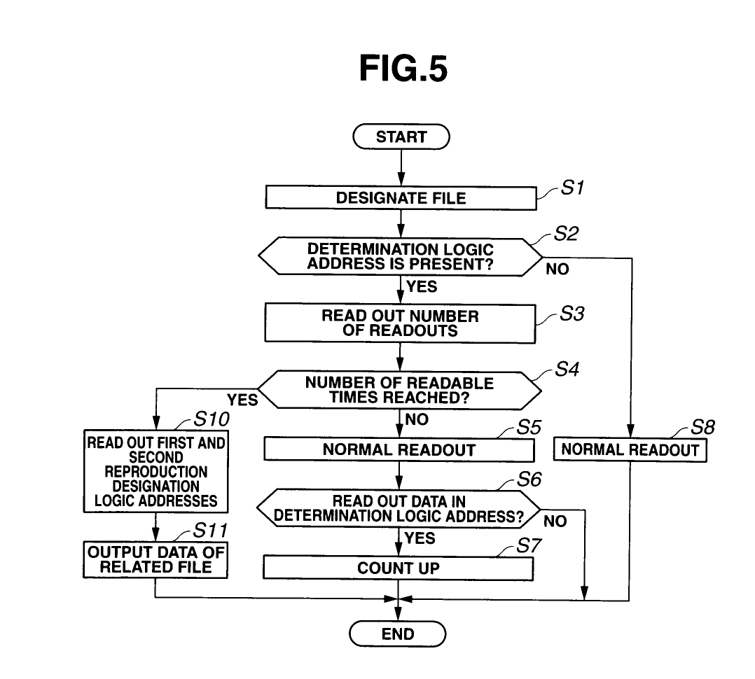

The operation of the embodiment configured as explained above is explained with reference to a flowchart of FIG. 5. In FIG. 5, steps same as those shown in FIG. 3 are denoted by the same reference signs and explanation of the steps is omitted.

In this embodiment, if the MPU 13 determines in step S4 that the number of readouts has reached the number of readable times, in step S10, the MPU 13 reads out the first and second reproduction designation logic addresses from the reproduction designation logic address storage area in the system management area. Subsequently, in step S11, the MPU 13 reads out the data of the related file stored in the auxiliary area and outputs the data as data between the first reproduction designation logic address and the second reproduction designation logic address equivalent to the start logic address.

In this way, after the number of readouts reaches the number of readable times, the data of the related file in the auxiliary area is output. For example, if advertisement information related to the number-of-reproductions limited file is stored as the related file, it is possible to reproduce the advertisement information according to designation of reproduction of the number-of-reproductions limited file.

As explained above, in this embodiment, after the number-of-reproductions limited file is reproduced a designated number of times of reproduction, the related file of the number-of-reproductions limited file is reproduced. Therefore, this embodiment is excellent in convenience for a provider of the number-of-reproductions limited file.

### Third Embodiment

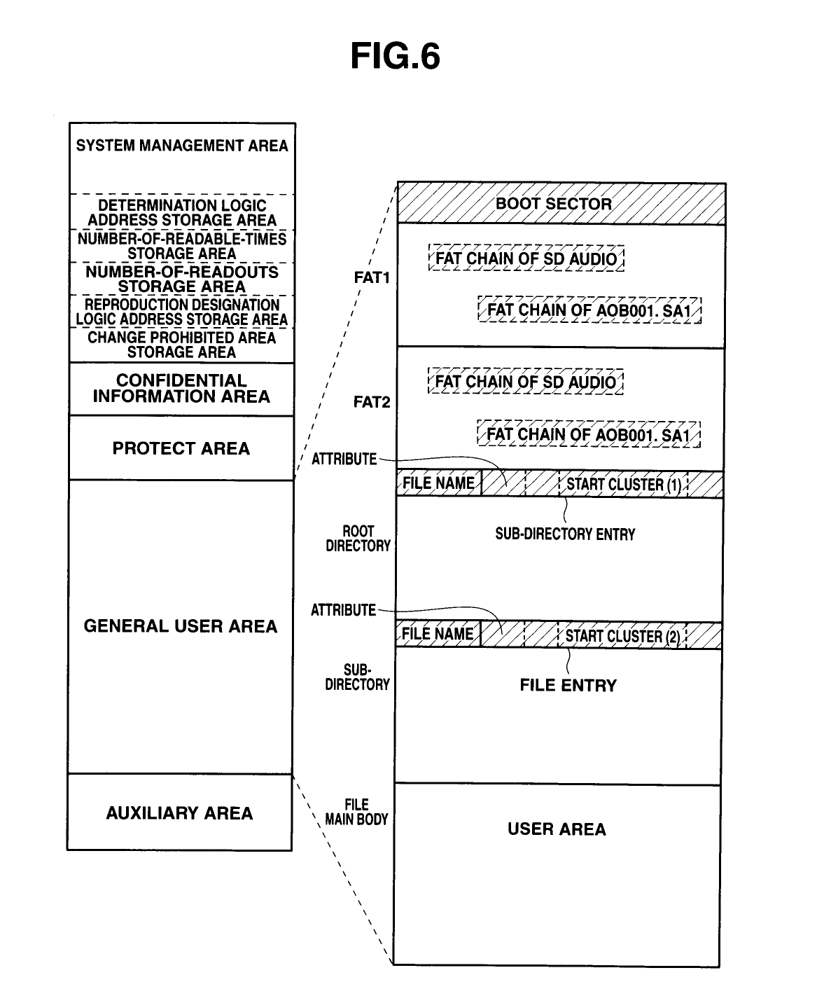

FIG. 6 is an explanatory diagram for explaining a third embodiment of the present invention. A hardware configuration of this embodiment is the same as that of the first embodiment. Only memory control by the MPU 13 is different from that of the first and second embodiments.

In the first and second embodiments, it is possible to perform limitation of a number of reproduction times with the memory card alone without using the function on the host side. Therefore, when the number-of-reproductions limited file stored in the memory section 21 is copied to another recording medium in which the first and second embodiments are not adopted, the number-of-reproductions limited file copied to the other recording medium can be reproduced many times exceeding the number of readouts.

Therefore, in this embodiment, the number of times of reproduction of the number-of-reproductions limited file is surely limited by making use of a copy protection technique adopted in an SD card or the like.

In writing a file in the memory section 21, the CPRM circuit 14 in the control section 11 performs writing of an encryption key according to CPRM rules. In the CPRM rules, the encrypted file is stored in a specified directory in the user area.

The CPRM circuit 14 causes the memory section 21 to store a generated encryption key in a directory in the protect area corresponding to the specified directory in the user area. In this case, the CPRM circuit 14 sets, as a file name of the encryption key, a file name associated with a file name of the file written in the user area.

During encryption, the CPRM circuit 14 retrieves, from the protect area, the encryption key corresponding to the file written in the user area. When the encryption key corresponding to the file is not retrieved from the protect area, the file written in the user area cannot be decrypted. Therefore, even if the number-of-reproductions limited file written in the user area is copied to the recording medium on the host side, since the corresponding encryption key is not copied to the recording medium at the copy destination, the file recorded in the recording medium at the copy destination cannot be decrypted.

However, if the number-of-reproductions limited file copied to the recording medium at the copy destination is written back to another address range of the user area of the memory section 21, even if the first and second embodiments are adopted, the written number-of-reproductions limited file can be reproduced many times.

Therefore, in this embodiment, the number of times of reproduction is limited by prohibiting writing of a file having a directory and a file name same as those of the number-of-reproductions limited file already written in the user area.

Specifically, in writing the number-of-reproductions limited file on the basis of an exclusive command from the host, the MPU 13 performs writing same as that in the first and second embodiments and writes, in a change prohibited area storage area in the system management area, information (a start address and an end address) concerning a change prohibited area in which information for accessing the number-of-reproductions limited file generated and written according to the writing is stored.

In FIG. 6, change prohibited areas are indicated by hatched portions. Specifically, in this embodiment, not only the boot sector but also a file entry for the number-of-reproductions limited file, a directory entry of a sub-directory in which the file is present, and recording areas of a FAT chain of the file entry for the file and a FAT chain for a body of the file are set by the MPU 13 as change prohibited areas in which a change of writing and the like is prohibited.

In writing the number-of-reproductions limited file, the MPU 13 writes information concerning the change prohibited areas in the system management area and, when a writing request is generated from the host side, reads out the information concerning the change prohibited areas and controls the writing. When there is writing data for changing a data value written in the change prohibited areas according to the writing request, the MPU 13 returns an error in response to the writing request and prevents writing in the memory section 21.

In some case, data writing is performed in sector unit of 512 bytes. Even in this case, the change prohibited areas are set in byte address unit. When writing data for changing a data value already written in the change prohibited areas is included in at least a part of the writing data in sector unit, the MPU 13 returns an error in response to the writing request and prevents data writing.

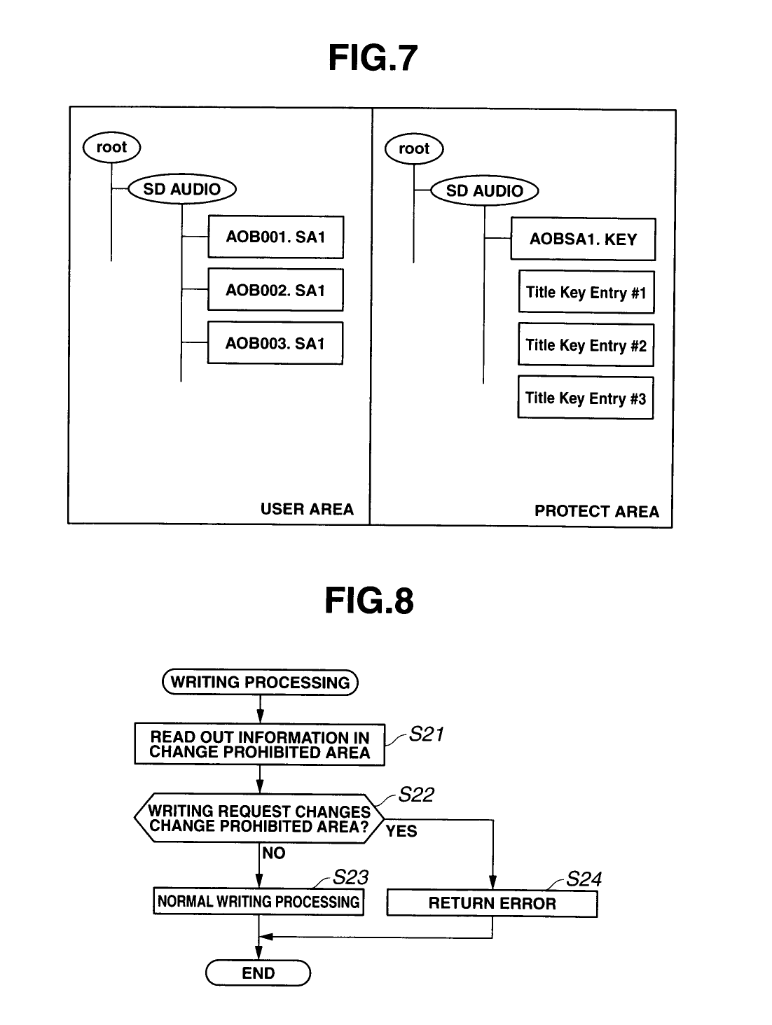

The operation of the embodiment configured as explained above is explained with reference to FIGS. 7 and 8. FIG. 7 is an explanatory diagram for explaining the operation of the CPRM circuit 14. FIG. 8 is a flowchart for explaining the operation of the MPU 13.

It is assumed that the MPU 13 writes the number-of-reproductions limited file in the memory section 21 according to an exclusive command from the host. In this case, the MPU 13 writes the first and second determination logic addresses, the number of readable times, the number of readouts, and the first and second reproduction designation logic addresses respectively in the determination logic address storage area, the number-of-readable-times storage area, the number-of-readouts storage area, and the reproduction designation logic address storage area in the system management area. Further, in this embodiment, the MPU 13 sets the recording areas for FAT chains generated according to writing of the number-of-reproductions limited file and the recording areas of sub-directory and file entries as the change prohibited areas. The MPU 13 writes start and end addresses of the change prohibited areas in the change prohibited area storage area in the system management area.

The CPRM circuit 14 writes the encryption key corresponding to the encrypted number-of-reproductions limited file in the protect area of the memory section 21. The general user area and the protect area of the memory section 21 adopts file systems independent from each other. User authentication is necessary in order to access the protect area.

As a specific example, in FIG. 7, a sub-directory “SD AUDIO” is present in the user area and number-of-reproductions limited files having file names AOB001.SA1, AOB001.SA2, and AOB001.SA3 are stored in the sub-directory.

The CPRM circuit 14 writes encryption keys corresponding to the files in the protect area. As a file name of each of the encryption keys, three characters at the top of the file name of the file to be encrypted and an extension are combined. KEY is added as the extension. For example, an encryption key having a file name “AOBSA1.KEY” is generated for the file having the file name “AOB001.SA1”. In the generated encryption keys, entries “Title Key Entry #1 to #3” respectively corresponding to the files “AOB001.SA1”, “AOB001.SA2”, and “AOB001.SA3” in the user area are included.

When a readout request for a file is received from the host, the CPRM circuit 14 retrieves an encryption key corresponding to a directory in which the requested file is stored and a file name of the file in the protect area corresponding to the directory and the file name. When the corresponding encryption key is present, the file requested to be read out is decrypted using the encryption key. In this way, the MPU 13 can output the file corresponding to the file readout request received from the host side.

However, when the encryption key having the file name corresponding to the file name of file requested to be read out is not present in the directory in the protect area corresponding to the directory in which the file requested to be read out is stored, the CPRM circuit 14 cannot read out the encryption key for the file requested to be read out. Thus, decryption for the file is not performed.

Therefore, in this embodiment, the MPU 13 sets, other than the boot sector, a file entry for the number-of-reproductions limited file, a directory entry of a sub-directory in which the file is present, and recording areas of a FAT chain of the file entry for the file and a FAT chain for a body of the file as change prohibited areas. The MPU 13 writes information concerning the change prohibited areas in the change prohibited area storage area in the system management area to prohibit the number-of-reproductions limited file to be rewritten in the same direction in the same file name.

In an example shown in FIG. 6, the file having the file name “AOB001.SA1” is written in the sub-directory “SD AUDIO” as the number-of-reproductions limited file. The MPU 13 reads out, in response to a readout request from the host, a sub-directory entry from a file name of a designated file and reads out a file entry referring to a FAT chain of “SD AUDIO” designated by the sub-directory entry. The MPU 13 reads out the file “AOB001.SA1” stored in the user area referring to a FAT chain of the file “AOB001.SA1” designated by the file entry and outputs the file “AOB001.SA1”.

As explained above, when the number-of-reproductions limited file having the file name “AOB001.SA1” is stored in a directory other than “SD AUDIO” or is changed to another file name, the CPRM circuit 14 cannot decrypt the number-of-reproductions limited file.

Therefore, even if the number-of-reproductions limited file already stored in the user area is stored in other directory or stored in another file name in response to a writing request from the host, the CPRM circuit 14 cannot decrypt the number-of-reproductions limited file.

In step S21 in FIG. 8, the MPU 13 reads out information in the change prohibited area in response to a writing request from the host. In step S22, the MPU 13 determines whether or not the writing request from the host is a writing request for changing a data value already stored in the change prohibited area. If the writing request does not involve a change of the change prohibited area, in step S23, the MPU 13 performs normal writing processing.

If the writing request involves a change of the change prohibited area, in step S24, the MPU 13 returns an error to the host and does not perform writing processing in the memory section 21.

As explained above, in this embodiment, a file having a same file name as that of a same sub-directory as that of the number-of-reproductions limited file cannot be deleted on a file system and cannot be replaced on another logic address. On the other hand, the CPRM circuit 14 associates a protection target file and an encryption key of the protect area using a file name (including a sub-directory name) of a content file. Therefore, even if the number-of-reproductions limited file is rewritten to the memory section 21, reproduction exceeding a designated number of reproducible times cannot be performed. It is possible to surely limit the number of times of reproduction to a desired number of times.

In the examples explained in the embodiments, the entire directory entry and the entire file entry are set as the change prohibited areas. However, a part in an entry (e.g., a file name, a file attribute, or a start cluster) may be set as the change prohibited area. In this case, other fields such as a file size and time information in the entry can be updated. However, deletion of a file on a file system and replacement of a file on another logic address cannot be performed.

In the embodiments, the example of the SD card is explained. However, the present invention can also be applied to other similar flash memory cards.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recording medium comprising:
a storing section including a first area in which a number-of-reproductions limited file is written and a second area in which at least one determination address in an address range of the first area, in which the number-of-reproductions limited file is written, and a number of readable times of the number-of-reproductions limited file are written; and
a control section configured to limit, after a number of readouts of reading out of data in the at least one determination address reaches the number of readable times, an output of the number-of-reproductions limited file in response to a readout request for the number-of-reproductions limited file.

2. The recording medium according to claim 1, wherein the control section does not perform, after the number of readouts of reading out of the data in the at least one determination address reaches the number of readable times, the output of the number-of-reproductions limited file in response to the readout request for the number-of-reproductions limited file.

3. The recording medium according to claim 1, wherein the control section outputs, after the number of readouts of reading out of the data in the at least one determination address reaches the number of readable times, a predetermined value instead of the output of the number-of-reproductions limited file in response to the readout request for the number-of-reproductions limited file.

4. The recording medium according to claim 1, wherein
the first area is provided in a user area in the storing section which can be accessed by a user; and
the second area is provided in a system area in the storing section which cannot be accessed by the user.

5. The recording medium according to claim 1, wherein
the address range of the first area is a range from a start address to an end address of the number-of-reproductions limited file written in the first area.

6. The recording medium according to claim 1, wherein
the storing section includes an area in which a number of readouts of the number-of-reproductions limited file is recorded, and
the control section compares, while updating the number of readouts every time the number-of-reproductions limited file is read out, the number of readouts with the number of readable times to determine whether or not the number of readouts of the number-of-reproductions limited file has reached the number of readable times.

7. The recording medium according to claim 1, wherein
the storing section includes a third area in which a related file related to the number-of-reproductions limited file is written,
first and second reproduction designation addresses, which are start and end positions of reproduction in the address range of the first area, are stored in the second area, and
the control section reads out, after the number of readouts of reading out of the data in the at least one determination address reaches the number of readable times, the related file in a range corresponding to a range of the second reproduction designation address from the first reproduction designation address and outputs the related file.

8. The recording medium according to claim 7, wherein the control section outputs, after the number of readouts of reading out of the data in the at least one determination address reaches the number of readable times, a predetermined value instead of the output of the number-of-reproductions limited file in response to a readout request for the number-of-reproductions limited file.

9. The recording medium according to claim 7, wherein the first area is provided in a user area in the storing section which can be accessed by a user, and
the second area is provided in a system area in the storing section which cannot be accessed by the user.

10. The recording medium according to claim 7, wherein
the address range of the first area is a range from a start address to an end address of the number-of-reproductions limited file written in the first area.

11. The recording medium according to claim 7, wherein
the storing section includes an area in which a number of readouts of the number-of-reproductions limited file is recorded, and
the control section compares, while updating the number of readouts every time the number-of-reproductions limited file is read out, the number of readouts with the number of readable times to determine whether or not the number of readouts of the number-of-reproductions limited file has reached the number of readable times.

12. The recording medium according to claim 1, wherein the control section generates, in the writing of the number-of-reproductions limited file, information necessary for access to the number-of-reproductions limited file and causes the first area to store the information and sets an area in which the information necessary for the access is stored in a change prohibited area and causes the second area to store information indicating a range of the change prohibited area.

13. The recording medium according to claim 12, wherein the control section encrypts, in the writing of the number-of-reproductions limited file, the number-of-reproductions limited file and causes the first are to store the number-of-reproductions limited file and causes a fourth area of the storing section to store decryption information for decrypting the encryption applied to the number-of-reproductions limited file in association with the information necessary for the access to the number-of-reproductions limited file.

14. The recording medium according to claim 12, wherein the control section outputs, after the number of readouts of reading out of the data in the at least one determination address reaches the number of readable times, a predetermined value instead of the output of the number-of-reproductions limited file in response to the readout request for the number-of-reproductions limited file.

15. The recording medium according to claim 12, wherein
the first area is provided in a user area in the storing section which can be accessed by a user; and
the second area is provided in a system area in the storing section which cannot be accessed by the user.

16. The recording medium according to claim 12, wherein
the address range of the first area is a range from a start address to an end address of the number-of-reproductions limited file written in the first area.

17. The recording medium according to claim 12, wherein
the storing section includes an area in which a number of readouts of the number-of-reproductions limited file is recorded, and
the control section compares, while updating the number of readouts every time the number-of-reproductions limited file is read out, the number of readouts with the number of readable times to determine whether or not the number of readouts of the number-of-reproductions limited file has reached the number of readable times.

18. The recording medium according to claim 12, wherein
the first area is logically formatted in a FAT format, and
the information necessary for the access includes all or a part of a file entry for the number-of-reproductions limited file and all or a part of a directory entry of a sub-directory in which the number-of-reproductions limited file is stored, as well as a FAT chain of the file entry for the number-of-reproductions limited file and a FAT chain for the number-of-reproductions limited file.
